(19) United States
(12) Patent Application Publication
(10) Pub. No.: US 2023/0308931 A1
(43) Pub. Date: Sep. 28, 2023

(54) COMMUNICATION NODE, COMMUNICATION SYSTEM, AND COMMUNICATION METHOD

(71) Applicant: Hitachi, Ltd., Tokyo (JP)

(72) Inventors: Taisuke Ueta, San Jose, CA (US); Shoji Yunoki, Santa Clara, CA (US); Tatsuya Maruyama, Santa Clara, CA (US)

(21) Appl. No.: 17/702,565

(22) Filed: Mar. 23, 2022

(51) Int. Cl. H04W 28/02; H04W 28/20

(52) U.S. Cl. CPC H04W 28/0221; H04W 28/0252; H04W 28/20; H04W 28/0268

(57) ABSTRACT

A method for a communication node is presented. The method may include storing, in the memory, a set of desired network performance characteristics for an application. The method may further include storing, in the memory, a plurality of traffic-control configurations, where each of the plurality of traffic-control configurations is associated with an estimated power usage and a set of estimated network performance characteristics. The method may also include selecting, to execute the application, a particular traffic-control configuration from a set of two or more traffic-control configurations in the plurality of traffic-control configurations, where the set of two or more traffic-control configurations meet the set of desired network performance characteristics for the application. The method may further include configuring the communication node based on the particular traffic-control configuration.

### BACKGROUND

### Field

The present disclosure is generally directed to traffic control at an edge server.

### Related Art

In recent years, not only cloud computing but also edge computing have been attracting attention with data growth due to the development of IoT (Internet of Things). In an edge computing system, edge servers, such as 5G MEC (Multi-access Edge Computing), are placed in the position near edge devices physically. The more fields they manage or the more advanced processes they execute, the more complicated their system may be due to an increased number of hardware resource. Edge servers are expected to utilize limited resource effectively. Considering the status of edge servers is necessary to the entire system performance. Currently, power constraints may be imposed by a method of deploying containers constrained by power profiles on a host system. However, with multiple options (e.g., interfaces) for traffic control, it is important that edge servers utilize resources effectively by selecting an optimized interface from a set of multiple interfaces while considering an applications network performance requirements. Additionally, it would be beneficial to allow dynamic monitoring of network performance in order to change between methods of traffic control based on the monitored network performance, an application's required network performance, and an estimated power usage associated with different traffic control methods.

### SUMMARY

Example implementations described herein include an innovative method for a communication node. The method may include storing, in the memory, a set of desired network performance characteristics for an application. The method may further include storing, in the memory, a plurality of traffic-control configurations, where each of the plurality of traffic-control configurations is associated with an estimated power usage and a set of estimated network performance characteristics. The method may also include selecting, to execute the application, a particular traffic-control configuration from a set of two or more traffic-control configurations in the plurality of traffic-control configurations, where the set of two or more traffic-control configurations meet the set of desired network performance characteristics for the application. The method may further include configuring the communication node based on the particular traffic-control configuration.

Example implementations described herein include an innovative computer-readable medium storing computer executable code for a communication node. The computer executable code may include instructions for storing, in the memory, a set of desired network performance characteristics for an application. The computer executable code may also include instructions for storing, in the memory, a plurality of traffic-control configurations, where each of the plurality of traffic-control configurations is associated with an estimated power usage and a set of estimated network performance characteristics. The computer executable code may further include instructions for selecting, to execute the application, a particular traffic-control configuration from a set of two or more traffic-control configurations in the plurality of traffic-control configurations, where the set of two or more traffic-control configurations meet the set of desired network performance characteristics for the application. The computer executable code may also include instructions for configuring the communication node based on the particular traffic-control configuration.

Example implementations described herein include an innovative apparatus for a communication node. The apparatus may include a memory and at least one processor configured to store, in the memory, a set of desired network performance characteristics for an application. The at least one processor may also be configured to store, in the memory, a plurality of traffic-control configurations, wherein each of the plurality of traffic-control configurations is associated with an estimated power usage and a set of estimated network performance characteristics. The at least one processor may further be configured to select, to execute the application, a particular traffic-control configuration from a set of two or more traffic-control configurations in the plurality of traffic-control configurations, wherein the set of two or more traffic-control configurations meet the set of desired network performance characteristics for the application. The at least one processor may also be configured to configure the communication node based on the particular traffic-control configuration.

### BRIEF DESCRIPTION OF DRAWINGS

FIG. 1 is a system configuration diagram of a communication system including an edge server which is a communication node according to some aspects of this disclosure.

FIG. 2 is a diagram showing an example application requirements table.

FIG. 3 is a diagram showing an example field status table.

FIG. 4 is a diagram showing an example traffic control patterns table.

FIG. 5 is a diagram showing an example system status table.

FIG. 6 is a flowchart illustrating a selection operation performed by the system.

FIG. 7 is a call flow diagram showing a set of communications associated with configuring a first traffic control pattern and a subsequent switching to a different traffic control pattern in the system of FIG. 1.

FIG. 8 is a diagram showing an example of a traffic pattern switch as described in relation to FIG. 7.

FIG. 9 is a diagram showing an example of a traffic pattern switch as described in relation to FIG. 7.

FIG. 10 is a diagram showing an example of a traffic pattern switch as described in relation to FIG. 7.

FIG. 11 is a diagram showing an example of a traffic pattern switch as described in relation to FIG. 7.

FIG. 12 is a flowchart diagram illustrating a switching operation of an orchestrator.

FIG. 13 is a flow diagram illustrating a method for providing traffic control for a set of applications.

FIG. 14 is a flow diagram illustrating a method for providing traffic control for a set of applications.

FIG. 15 is a flow diagram illustrating a method for updating a traffic control configuration based on monitoring network traffic performance associated with an application.

FIG. 16 is a flow diagram illustrating a method for updating a traffic control configuration based on monitoring power consumption associated with an application.

FIG. 17 is a flow diagram illustrating a method for updating a traffic control configuration based on an updated set of desired network performance characteristics associated with an application.

FIG. 18 is a flow diagram illustrating a method for updating a set of traffic control configurations based on an updated set of desired network performance characteristics associated with an application.

FIG. 19 illustrates an example computing environment with an example computer device suitable for use in some example implementations.

### DETAILED DESCRIPTION

The following detailed description provides details of the FIGs. and example implementations of the present application. Reference numerals and descriptions of redundant elements between FIGs. are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm Example implementations as described herein can be utilized either singularly or in combination and the functionality of the example implementations can be implemented through any means according to the desired implementations.

In this disclosure, a communication node and a communication system is presented that controls the methods of traffic control at the communication node (e.g., the edge server). Each traffic control method may consume a different amount of power depending on its performance or the hardware that it is executed on. By balancing the requirements for the system including network performance and the processing power needed associated with each method, the system may provide optimized traffic control.

Example implementations described herein include an innovative method for a communication node. The method may include storing, in the memory, a set of desired network performance characteristics for an application. The method may further include storing, in the memory, a plurality of traffic-control configurations, where each of the plurality of traffic-control configurations is associated with an estimated power usage and a set of estimated network performance characteristics. The method may also include selecting, to execute the application, a particular traffic-control configuration from a set of two or more traffic-control configurations in the plurality of traffic-control configurations, where the set of two or more traffic-control configurations meet the set of desired network performance characteristics for the application. The method may further include configuring the communication node based on the particular traffic-control configuration.

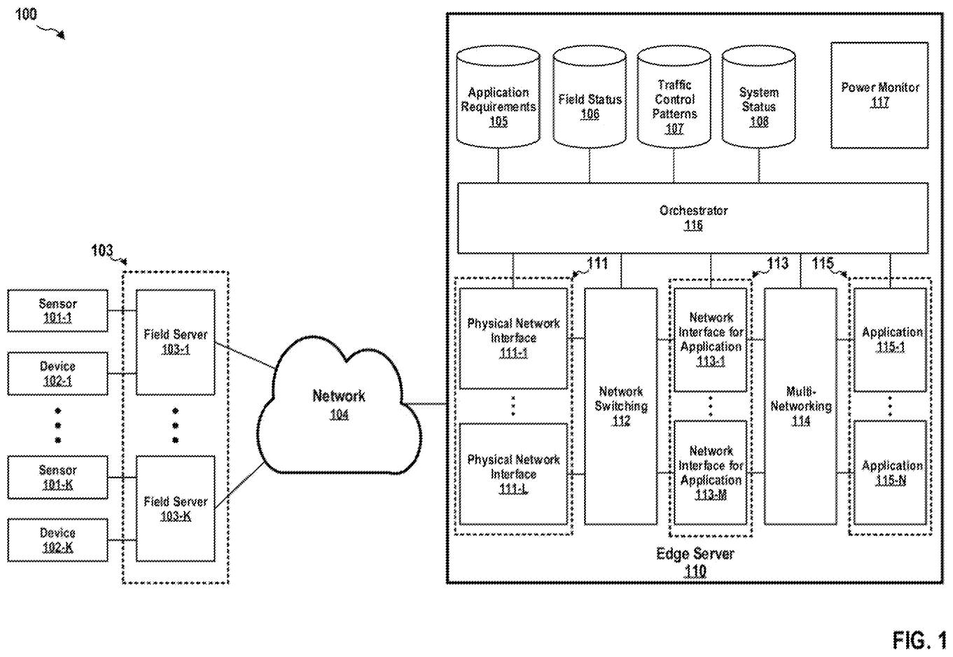

FIG. 1 is a system configuration diagram of a communication system 100 including an edge server 110 which is a communication node according to some aspects of this disclosure. The edge server 110, in some aspects, connects to a set of ‘K’ field servers 103 including a first field server 103-1 to a K-th field server 103-K via a communication network 104. The first field server 103-1, in some aspects, connects field devices such as a first sensor 101-1 and a first device 102-1. The K-th field server 103-K, in some aspects, connects field devices such as a K-th sensor 101-K and a K-th device 102-K.

The edge server 110, in some aspects, includes a set of ‘L’ physical network interfaces 111 including a first physical network interface 111-1 to an L-th physical network interface 111-L, a network switching module 112, a set of ‘M’ network interfaces for applications 113 for applications including a first network interface for application 113-1 to an M-th network interface for application 113-M, a multi networking module 114, a set of ‘N’ applications 115 including a first application 115-1 to an N-th application 115-N, an orchestrator 116, a power monitor 117, an application requirements table 105, a field status table 106, a traffic control patterns table 107, and a system status table 108.

The physical network interfaces 111, in some aspects, may acquire, from the field servers 103, field data such as field devices status. The physical network interfaces may also, in some aspects, send control data such as command data to control field devices and feedback data to the field devices based on data analysis executed on the edge server 110. The physical network interfaces 111 may include a processor such as an accelerator to control the traffic of the field data and the control data. The network switching module 112, in some aspects, connects the physical network interfaces 111 and the network interfaces for applications 1113. The network switching module 112 in some aspects, includes a network stack of a host operating system (OS) and provides traffic control functions. The network switching module 112 may include a physical network switching device. In some aspects, the network interfaces for applications 113 include virtual network interfaces, such as a virtual network interface card (NIC) or container network interfaces, which may provide traffic control functions based on a virtual machine's network stack or a container's network stack. The multi networking module 114, in some aspects, may connect the network interfaces for applications 113 and the applications 115 to provide the applications 115 with multiple network interfaces. In some aspects, the applications 115 may be applications executed on virtual machines or containers. The applications 115 may leverage more than one of the network interfaces for applications 113 directly. The orchestrator 116, in some aspects, may manage and select the traffic control patterns inside the edge server 110 based on information in the application requirements table 105, the field status table 106, the traffic control patterns table 107, and the system status table 108. The power monitor 117, in some aspects, estimates and monitors power consumption inside the edge server 110. In some aspects, the power monitor 117 calculates power consumption for each traffic control pattern described in the traffic control patterns table 107.

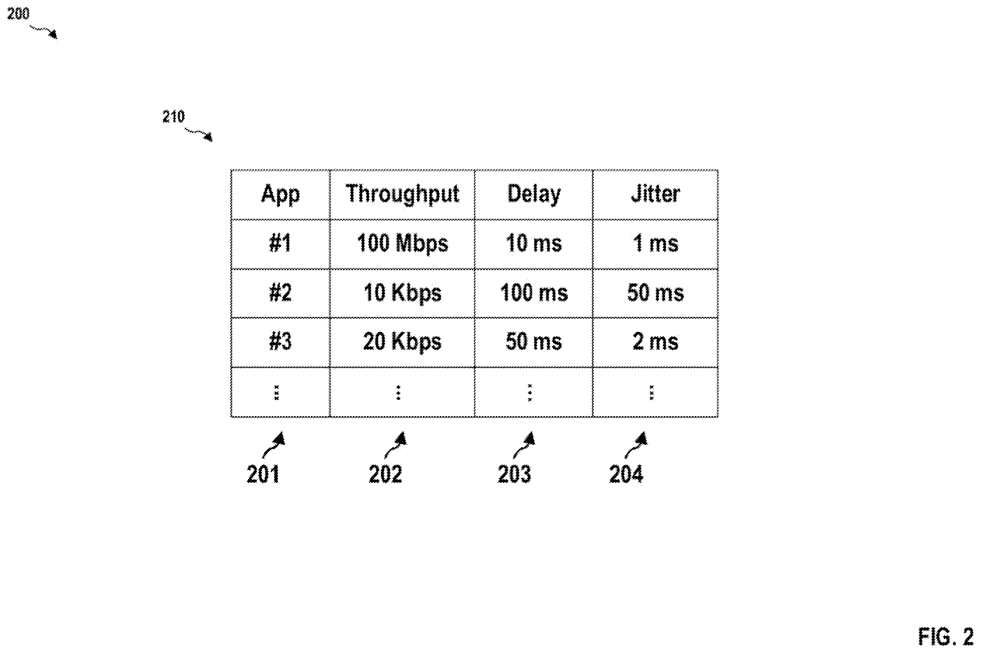

FIG. 2 is a diagram 200 showing an example application requirements table 210. The application requirements table 210, in some aspects, may store information regarding a set of desired network performance characteristics or network performance requirements of the applications 115 of FIG. 1. For example, the application requirements table 210 may include a set of fields including an application ID field 201 storing an application ID associated with a corresponding value (or range of values) in each of a throughput field 202, a delay field 203, and a jitter field 204. The application ID field 201, in some aspects, identifies the applications (e.g., applications 115 of FIG. 1). The application requirements table 210 may represent an example of the application requirements table 105 that is referenced by the orchestrator 116 of FIG. 1.

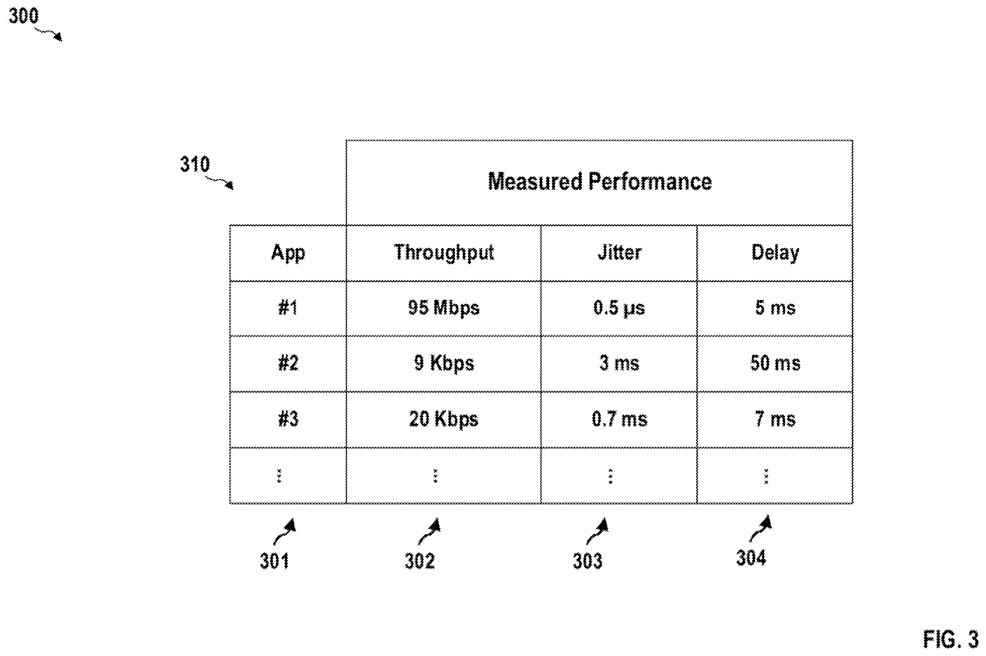

FIG. 3 is a diagram 300 showing an example field status table 310. The field status table 310 (e.g., an example of a field status table 106) may store information of the result data of network performance. The network performance, in some aspects, may be measured by one or more field servers (e.g., field servers 103 of FIG. 1), for each of the applications (e.g., applications 115 of FIG. 1). The field status table 310 includes a set of fields including an application ID field 301 storing an application ID associated with a measured throughout in a corresponding throughput field 302, a measured jitter in a corresponding jitter field 303, and a measured delay in a corresponding delay field 304. The application ID stored in application ID field 301, in some aspects, corresponds to the same application IDs (and applications, e.g., the applications 115 of FIG. 1) as the application IDs in the application ID field 201 shown in FIG. 2. The field status table 310 may represent an example of the field status table 106 that is referenced by the orchestrator 116 and updated by the applications 115 of FIG. 1. The field servers 103 and the edge server 110 may be synchronized via the communication network 104 by time synchronization such as Precision Time Protocol (PTP).

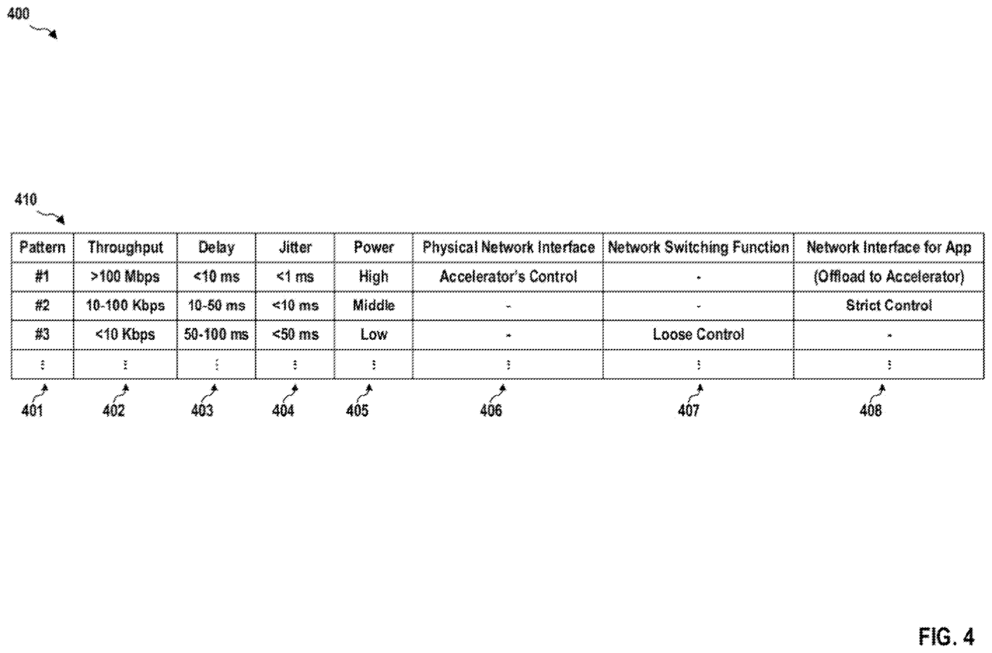

FIG. 4 is a diagram 400 showing an example traffic control patterns table 410. The traffic control patterns table 410 (e.g., an example of a traffic control patterns table 107), in some aspects, may store information regarding the configuration patterns for traffic control, which an edge server (e.g., the edge server 110) provides. The stored information may include an estimated power usage and a set of estimated network performance characteristics corresponding to characteristics identified in the application requirements table 105 or 210 of FIGS. 1 and 2. For example, the traffic control patterns table 410 includes a set of fields including a pattern ID field 401, a throughput field 402, a delay field 403, a jitter field 404, a power field 405, a physical network interface field 406, a network switching function field 407, and a network interface for application field 408. The pattern ID in a pattern ID field 401 identifies the configuration of a traffic control pattern. The throughput field 402, the delay field 403, and the jitter field 404, in some aspects, may represent a predicted network performance for each of the traffic control patterns in the traffic control patterns table 410. A value associated with the power field 405, in some aspects, represents an estimated power consumption for a corresponding traffic control pattern identified in the pattern ID field 401. The physical network interface field 406, the network switching function field 407, and the network interface for application field 408 indicate, for a corresponding traffic control pattern in some aspects, a configuration of traffic control including functions provided by the physical network interfaces 111, the network switching module 112, and the network interfaces for applications 113.

For instance, referring to FIGS. 1 and 4, the first line shown in FIG. 4 may be associated with pattern ID #1 and indicates that “Accelerator's Control” is stored in the physical network interface field 406, “-” is stored in the network switching function field 407, and “Offload to Accelerator” is stored in the network interface for application field 408. This example indicates that, when the pattern ID is “#1”, the edge server 110 provides the traffic control function with the physical network interfaces 111. The physical network interfaces 111 may include a dedicated hardware, such as a processor or a logic circuit, to accelerate the traffic control function.

The second line shown in FIG. 4 may be associated with pattern ID #2 and indicates that “-” is stored in the physical network interface field 406, “-” is stored in the network switching function field 407, and “Strict Control” is stored in the network interface for application field 408. This example indicates that, when the pattern ID is “#2”, the edge server 110 may provide the traffic control function with a network interface for applications (e.g., network interface for application 113-1 in the set of network interfaces for applications 113). The network interface for application may include a virtual network interface that supports single rot input/output virtualization (SR-10V) and data plane development kit (DPDK) to provide the application 115 with a strict traffic control. The network interface for application may include a container network interface that supports a strict traffic control function utilizing the container's network stack.

The third line shown in FIG. 4 may be associated with pattern ID #3 and indicates that “-” is stored in the physical network interface field 406, “Loose Control” is stored in the network switching function field 407, and “-” is stored in the network interface for application field 408. This example indicates that, when the pattern 11) is “3”, the edge server 110 provides the traffic control function with the network switching module 112. The network switching module 112 may utilize a network stack of a host OS that supports queuing disciplines to provide the application 115 with a loose traffic control. The network switching module 112 may include a physical network switching device to provide the Applications 115 with a traffic control function dedicatedly. An edge server (e.g., edge server 110), in some aspects, may update a traffic control patterns table (e.g., traffic control patterns table 107) with power consumption monitored by a power monitor (e.g., power monitor 117). The edge server, in some aspects, may generate a set of additional traffic control patterns in traffic control patterns table 410 based on the entries in a field status table (e.g., field status table 106) for each application ID in an application ID field 301.

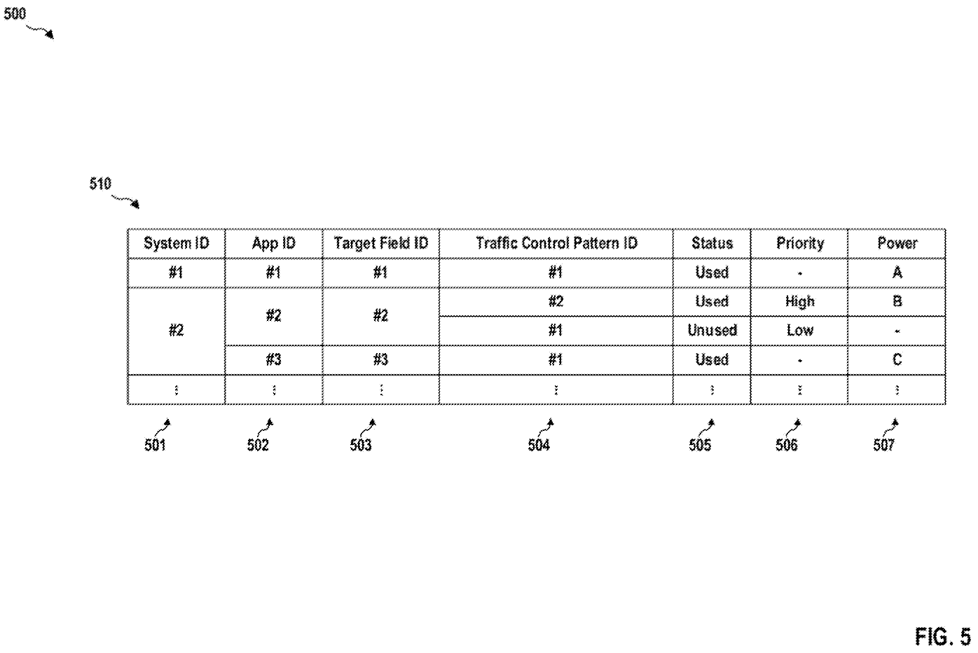

FIG. 5 is a diagram 500 showing an example system status table 510. The system status table 510, in some aspects, stores information of the system status of a communication system managed by an edge server (e.g., the communication system 100 of FIG. 1 managed by the edge server 110). The system status table 510 includes a set of fields including a system ID field 501, an app ID field 502, a target field ID field 503, a traffic control pattern ID field 504, a status field 505, a priority field 506, and a power field 507. The system ID field 501 manages applications as a system and identifies the relationship between the application and the field side, such as the field servers with which the edge server communicates. The app ID field 502 indicates an ID of an associated application 115. The target field 11) field 503 indicates the ID of the associated field side. The traffic control pattern ID field 504 identifies the pattern ID 401 shown in FIG. 4. The status field 505 indicates, in some aspects, whether the traffic control pattern indicated in the traffic control pattern ID field 504 is used or not. The priority field 506 shows the priority of the traffic control pattern indicated in the traffic control pattern ID field 504 for each of the application IDs in app ID field 502. The priority may be determined based on the power indicated in power field 405 shown in FIG. 4. The power field 507 may indicate a power usage, or power usage level. The power usage or power usage level stored in the power field 507 may be a power usage measured by a power monitor (e.g., power monitor 117 of FIG. 1). In some aspects, an edge server (e.g., edge server 110) may accommodate a set of applications and determine (and adjust) the corresponding traffic control patterns while maintaining an aggregated power consumption (e.g., an aggregated power usage) limit configured for the edge server.

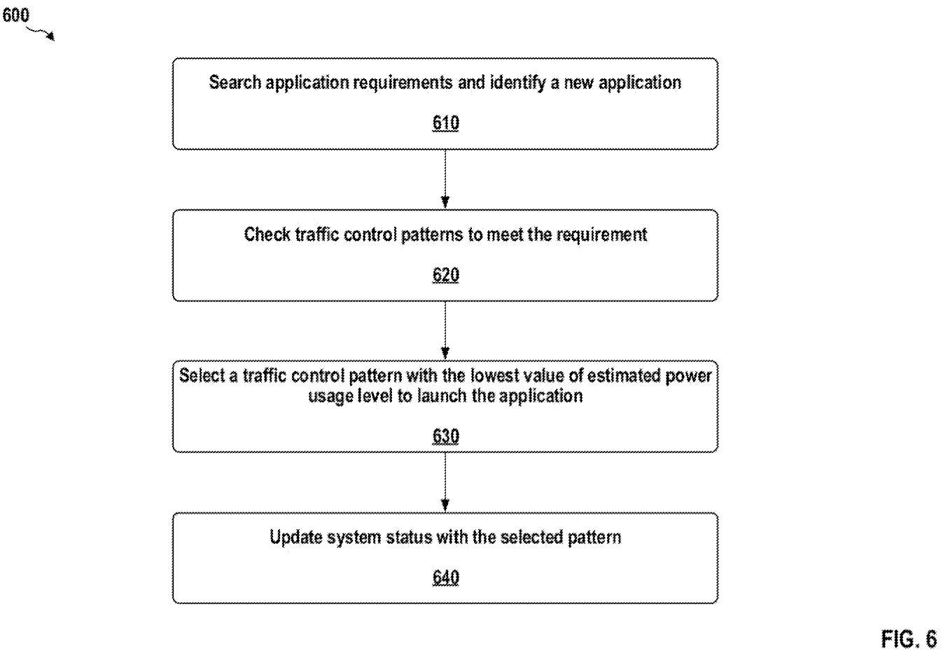

FIG. 6 is a flowchart 600 illustrating a selection operation performed by the system. In some aspects, the selection operation is performed by an orchestrator (e.g., the orchestrator 116). In some aspects, the system, (e.g., the orchestrator 116), may begin execution of the selection operation when an application requirements table (e.g., application requirements table 105 or 210) is updated. The system. (e.g., the orchestrator 116) may check the application requirements table for updates periodically.

At 610, the system (e.g., the orchestrator 116) may search the application requirements table and identify a new application. The new application may be associated with a set of application requirements. For example, a new application may be associated with a threshold throughput (e.g., a minimum throughput), a threshold delay (e.g., a maximum delay), and/or a threshold jitter (a maximum jitter). For example, referring to FIGS. 1, 2, and 4, an orchestrator 116 may identify from an application requirements table (e.g., application requirements table 105 or 210) a first application #1 that is associated with a requirement for a minimum throughput of 100 Mbps, a maximum delay of 10 ms, and a maximum jitter of 1 ms and a second application #2 that is associated with a requirement for a minimum throughput of 10 Kbps, a maximum delay of 100 ms, and a maximum jitter of 50 ms

At 620, the system (e.g., the orchestrator 116) may check the traffic control patterns of a traffic control patterns table (e.g., the traffic control patterns table 107 or 410) to identify one or more traffic control patterns that meet the requirement for the identified new application. For example, referring to FIGS. 1, 2, and 4, an orchestrator 116 may identify a traffic control pattern ID #1 that meets the requirements for application #1 and a set of traffic control pattern IDs #1 and #2 that both meet the requirements for application #2.

At 630, the system (e.g., the orchestrator 116) may select a traffic control pattern from the traffic control patterns identified at 620. In some aspects, the selected traffic control pattern with the lowest value of estimated power usage (or usage level) to associate with (or to launch for) the new application. For example, referring to FIGS. 1, 4, and 5, an orchestrator 116 may select, for the application #2, the traffic control pattern identified by traffic control pattern ID #2 over the traffic control pattern identified by traffic control pattern ID #1.

Finally, at 640 the system (e.g., the orchestrator 116) may update a system status table (e.g., system status table 108 or 510) with the selected pattern. In the case that there are several patterns to meet the requirement (e.g., for the application associated with application ID #2), the system may set the priority based on the value of estimated power usage level. For example, referring to FIGS. 1, 4, and 5, the orchestrator 116 may update a system status table 108 or 510 with information for each application in a set of applications identified in app ID field 502 regarding a field device (e.g., one of the field servers 103) associated with the application (e.g., in target field ID field 503), traffic control patterns (e.g., identified in traffic control patterns table 107 or 410) that meet the requirements associated with the application (e.g., in traffic control pattern ID field 504), a status of the traffic patterns identified in traffic control pattern ID field 504 (e.g., in status field 505), and apriority (or relative priority) of the traffic control patterns associated with a same application (e.g., in priority field 506).

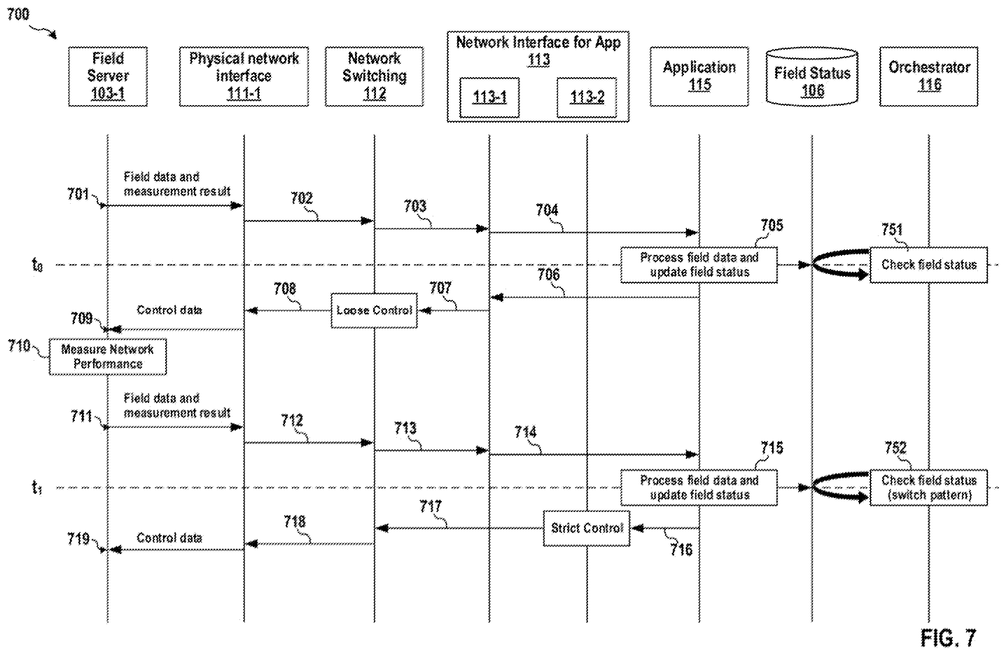

FIG. 7 is a call flow diagram 700 showing a set of communications associated with configuring a first traffic control pattern and a subsequent switching to a different traffic control pattern in the communication system 100 of FIG. 1. FIG. 7 shows a sequence of communications between a first field server 103-1 (e.g., a field server in the set of field servers 103), the first physical network interface 111-1 (e.g., a physical network interface in the set of physical network interfaces 111), the network switching module 112, the network interfaces for applications 113 (e.g., 113-1, 113-2), the application 115, and the orchestrator 116 by using the example in which the two traffic control patterns associated with the application ID #2 (in app ID field 502) shown in FIG. 5 are switched in the edge server 110 based on the field data from the field servers 103. FIG. 7 shows an example sequence when the application requirements table 105, the traffic control patterns table 107, and the system status table 108 are configured as shown in FIG. 2. FIG. 4, and FIG. 5 respectively.

For example, a first field server 103-1 may transmit a field data and measurement result in communication 701 to a first physical network interface 111-1. The first physical network interface 111-1 may, in turn, transmit communication 702 related to the field data and measurement result in communication 701 to network switching module 112. The network switching module 112 may then transmit communication 703 (related to communications 701 and 702) to a first network interface for application 113-1 in the set of network interfaces for applications 113. The first network interface for application 113-1 may then transmit the communication 704 to application 115. The application may, at 705, process the field data and may update a field status in a field status table 106. The orchestrator 116 may query the field status table 106 or otherwise check, at 751, the field status associated with the application. The application may communicate control data via communications 706, 707, 708, and 709 to the first field server 103-1 via the same route in reverse with the network switching providing loose control as indicated between communications 707 and 708.

At 710, the first field server 103-1 may measure network performance associated with the application 115 and communicate field data and measurement result via communications 711, 712, 713, and 714 similarly to communications 702, 703, and 704. The application 115 may, at 715, process the field data and measurement result in communication 711 and update the field status. The orchestrator 116 may query the field status table 106 or otherwise check, at 752, the field status associated with the application. The orchestrator may identify that the network performance indicated in field data and measurement result in communication 711 does not meet the requirements specified in an application requirements table and may indicate for a different traffic control pattern to be used. Accordingly, the reverse path for control data, e.g., communications 716, 717, 718, and 719, may include a different network interface for application 113-2 that applies strict control before reaching the network switching module 112.

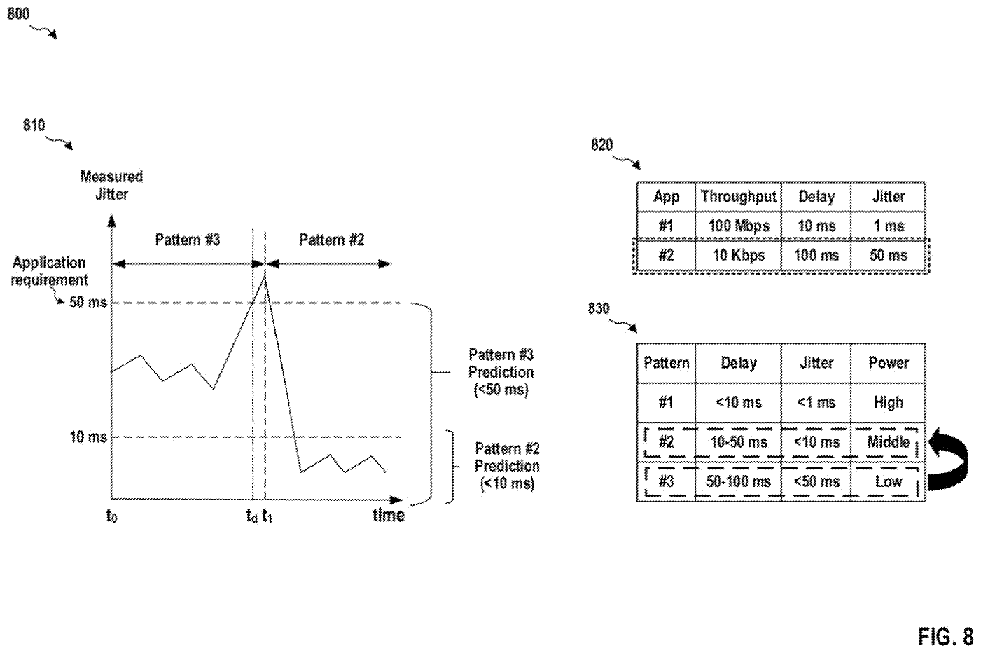

FIG. 8 is a diagram 800 showing an example of a traffic pattern switch as described in relation to FIG. 7. For example, App #2 in application table 820 may be associated with a requirement for jitter to be less than 50 ins. The system, e.g., a field server 103 of the communication system 100 of FIG. 1, may monitor a jitter associated with App #2 as illustrated in diagram 810. In diagram 810, the vertical axis indicates the measured jitter and the horizontal axis indicates the time at which the jitter is measured. From a time t₀ to a time t₁ the system may use traffic control pattern #3. The traffic control pattern #3 may be selected from the traffic control patterns #2 and #3 in traffic control pattern table 830 that each meet the requirements of App #2 based on being associated with a lower expected power usage, or expected power usage level. At time t_{d} the system may measure (e.g., at 710) a jitter that is above the jitter threshold associated with App #2 and determine to switch to traffic control pattern #2 at the time t₁. The time delay between t_{d} and t₁ may be based on a processing time for detecting that the threshold has been exceeded, determining another traffic control pattern to use, and configuring the components of the edge server to implement the determined traffic control pattern.

For example, referring to FIGS. 1 and 7, the field server 103 may transmit the field data and the measurement result to the edge server 110 via communication 701. In the edge server 110, the field data and the measurement result are transferred to the application 115 via the first physical network interface 111-1, the network switching module 112, and the network interface for application 113-1 in communications 702-704. Note that, in FIG. 7, the network interface for application 113-1 is the network interface in the set of network interfaces for applications 113 associated with the traffic control pattern ID #3. The application 115, at 705, processes the field data and updates the field status table 106 based on the measurement result.

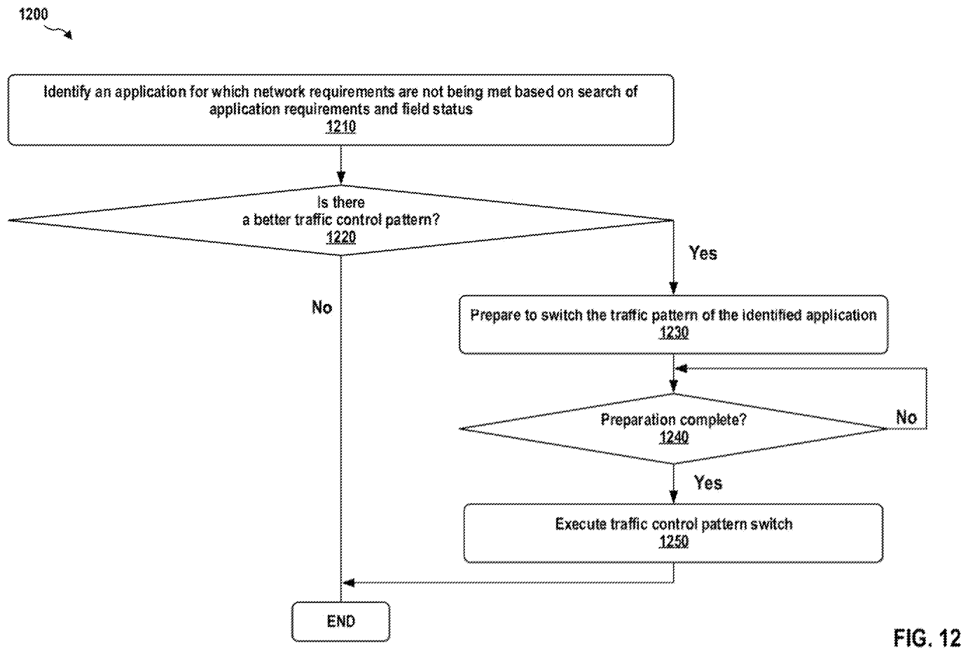

Meanwhile, the orchestrator 116 checks the field status table 106 to manage and select the traffic control patterns at 751. This operation of the orchestrator 116 will be explained in more detail in relation to FIG. 12 below. At this time (e.g., a time t₀) the orchestrator 116 does not switch the traffic control patterns because the traffic control pattern #3 meets the requirement of the App #2. The control data is transferred from the application 115 to the field server 103 via the network interface for application 113-1, the network switching module 112, and the first physical network interface 111-1 via communications 706-709. The network switching module 112 executes the loose control based on the traffic control pattern #3.

As described above, the field server 103 may measure network performance at 710 (e.g., at time t_{d}) and transmits the field data and the measurement result to the edge server 110 via communication 711 (via first physical network interface 111-1). The field data and the measurement result are transferred to the application 115 via the first physical network interface 111-1, the network switching module 112, and the network interface for application 113-1 via communications 712-714. The application 115, at 715, processes the field data and updates the field status table 106 based on the measurement result.

Meanwhile, the orchestrator 116, at 752, checks the field status table 106 to manage and select the traffic control patterns. At this time (e.g., time t₁) the orchestrator 116 may switch the traffic control patterns because the traffic control pattern #3 does not seem to meet the requirement of the App #2. The control data is transferred from the application 115 to the field server 103 via the network interface for application 113-2, the network switching module 112, and the first physical network interface 111-1 in communications 716-719. The network interface for application 113-2 is used as the network interface for application 113 of the traffic control pattern #2. The network interface for application 113-2 executes the strict control based on the traffic control pattern #2.

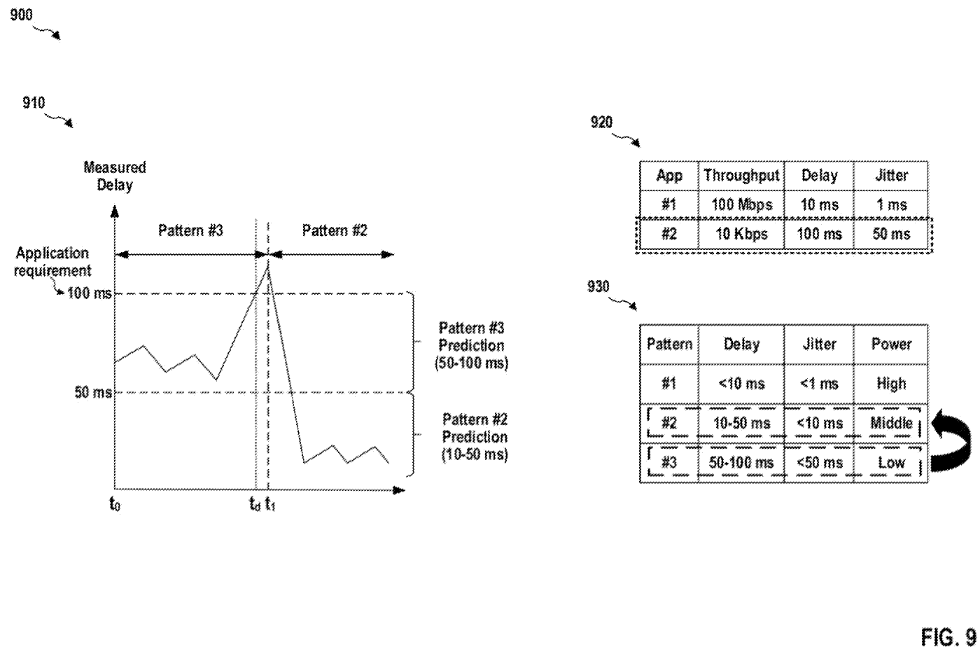

FIG. 9 is a diagram 900 showing an example of a traffic pattern switch as described in relation to FIG. 7. For example, App #2 in application table 920 may be associated with a requirement for delay to be less than 100 ms. The system, e.g., a field server 103 of the communication system 100 of FIG. 1, may monitor a delay associated with App #2 as illustrated in diagram 910. In diagram 910, the vertical axis indicates the measured delay and the horizontal axis indicates the time at which the delay is measured. From a time t₀ to a time t₁ the system may use traffic control pattern #3. The traffic control pattern #3 may be selected from the traffic control patterns #2 and #3 in traffic control pattern table 930 that each meet the requirements of App #2 based on being associated with a lower expected power usage, or expected power usage level. At time t_{d} the system may measure (e.g., at 710) a delay that is above the delay threshold associated with App #2 and determine to switch to traffic control pattern #2 at time t₁.

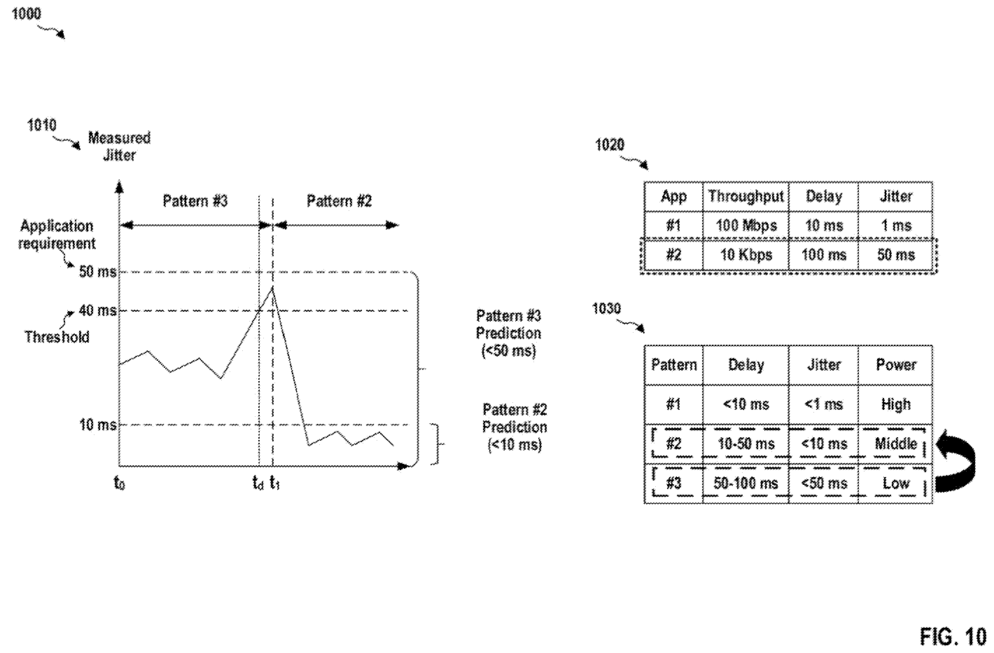

FIG. 10 is a diagram 1000 showing an example of a traffic pattern switch as described in relation to FIG. 7. For example, App #2 in application table 1020 may be associated with a requirement for jitter to be less than 50 ms. App #2 may also be associated with a threshold of 40 ms for jitter to ensure that the requirement for jitter to be less than 50 ms will be met by switching traffic control patterns before the network fails to meet the requirement that the jitter be less than 50 ms. The system, e.g., a field server 103 of the communication system 100 of FIG. 1, may monitor a jitter associated with App #2 as illustrated in diagram 1010. In diagram 1010, the vertical axis indicates the measured jitter and the horizontal axis indicates the time at which the jitter is measured. From a time t₀ to a time t₁ the system may use traffic control pattern #3. The traffic control pattern #3 may be selected from the traffic control patterns #2 and #3 in traffic control pattern table 1030 that each meet the requirements of App #2 based on being associated with a lower expected power usage, or expected power usage level. At time t_{d} the system may measure (e.g., at 710) a jitter that is above the jitter threshold (e.g., above 40 ms) associated with App #2 and determine to switch to traffic control pattern #2 at time t₁.

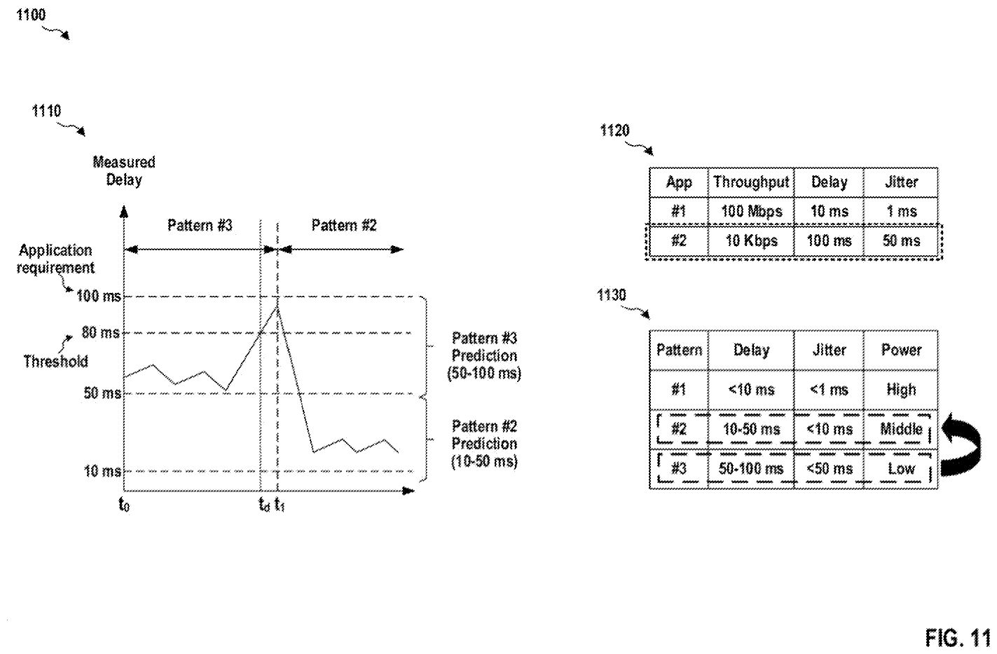

FIG. 11 is a diagram 1100 showing an example of a traffic pattern switch as described in relation to FIG. 7. For example, App #2 in application table 1120 may be associated with a requirement for delay to be less than 100 ms. App #2 may also be associated with a threshold of 80 ms for delay to ensure that the requirement for delay to be less than 100 ms will be met by switching traffic control patterns before the network fails to meet the requirement that the delay be less than 100 ms. The system, e.g., a field server 103 of the communication system 100 of FIG. 1, may monitor a delay associated with App #2 as illustrated in diagram 1110. In diagram 1110, the vertical axis indicates the measured delay and the horizontal axis indicates the time at which the delay is measured. From a time t₀ to a time t₁ the system may use traffic control pattern #3. The traffic control pattern #3 may be selected from the traffic control patterns #2 and #3 in traffic control pattern table 1130 that each meet the requirements of App #2 based on being associated with a lower expected power usage, or expected power usage level. At time t_{d} the system may measure (e.g., at 710) a delay that is above the delay threshold (e.g., above 80 ms) associated with App #2 and determine to switch to traffic control pattern #2 t₁.

FIG. 12 is a flowchart diagram 1200 illustrating a switching operation of an orchestrator (e.g., orchestrator 116). The orchestrator, in some aspects, starts the execution of this operation periodically. The orchestrator, in some aspects, may start the execution when an application updates the field status table. At 1210, the orchestrator may search an application requirements table (e.g., the application requirements table 105) and a field status table (e.g., field status table 106) and identifies an application (e.g., the applications 115) for which network requirements are not met based on the field status. For example, referring to FIGS. 7-11, the orchestrator 116, at 752, may search the field status table 106 and an application requirements table (e.g., application requirements table 820, 920, 1020, or 1120) to identify that the network requirements for application 115 are not being met as illustrated in FIGS. 8-11.

At 1220, the orchestrator may determine whether there is a better traffic control pattern for the application identified at 1210. If the orchestrator determines, at 1220, that there is no better traffic control pattern for the identified application, the switching operation ends. However, if the orchestrator determines that there is at least one better traffic control pattern for the application identified at 1210, the orchestrator may prepare, at 1230, to switch the traffic pattern of the application identified at 1210. In some aspects, this preparation may be executed in advance. For example, referring to FIGS. 5 and 8-11, the orchestrator may determine based on a system status table 510 that there is at least one other traffic control pattern (e.g., that meets the network appliance requirements of the application.

At 1240, the orchestrator may determine whether the preparation is complete or not. If the orchestrator determines, at 1240, that the preparation is not complete, the orchestrator may return to 1240 to determine whether the preparation is complete. If the orchestrator determines, at 1240, that the preparation is complete, the orchestrator may execute, at 1250 the switching of the traffic pattern and end the operation.

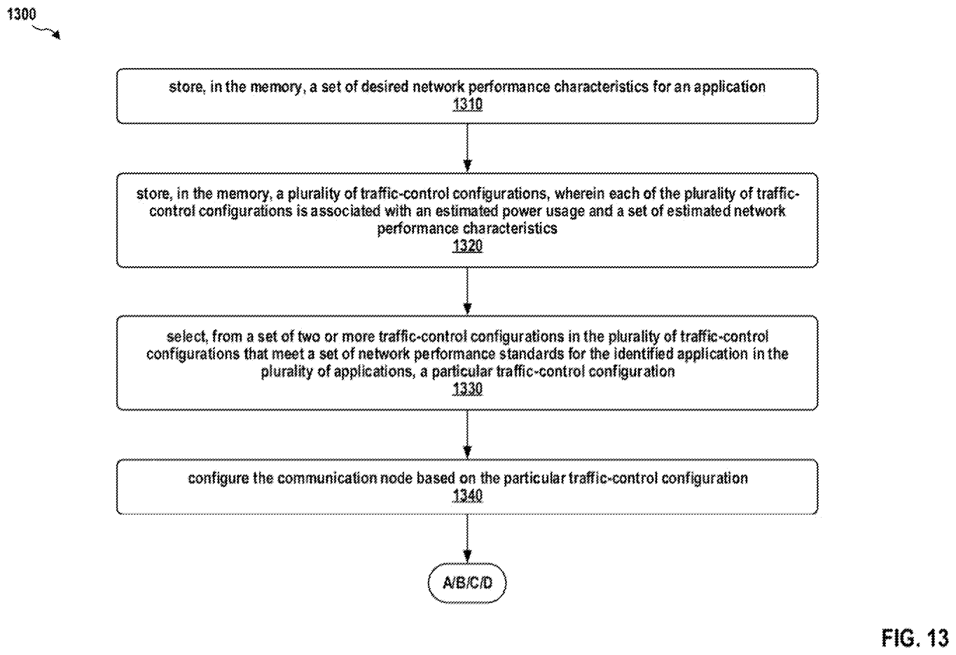

FIG. 13 is a flow diagram 1300 illustrating a method for providing traffic control for a set of applications. The method may be performed by a system, and more specifically an edge server (e.g., edge server 110) or an orchestrator of the edge server (e.g., orchestrator 116). At 1310, the edge server may store, in the memory, a set of desired network performance characteristics for an application. In some aspects, the edge server may store, in the memory, a plurality of sets of desired network performance characteristics for a plurality of applications. The set of desired network performance characteristics, in some aspects, may include one or more of a minimum throughput, a threshold jitter, or a threshold delay. For example, referring to FIGS. 1 and 2, the edge server 110 may store one or more sets of desired network performance characteristics in an application requirements table 105 or 210, where the application requirements table 105 or 210 may be stored in a memory of the edge server.

At 1320, the edge server may store, in the memory, a plurality of traffic-control configurations, wherein each of the plurality of traffic-control configurations is associated with an estimated power usage and a set of estimated network performance characteristics. In some aspects, the estimated network performance characteristics relate to one or more of a throughput, a jitter, or a delay. The estimated power usage, in some aspects, may include one or more of a numerical value (or range) associated with the estimated power usage or an estimated power-usage level. In some aspects, the estimated power-usage level includes one of a high power-usage level, a medium power-usage level, or a low power-usage level. In other aspects, the estimated power-usage level may include a more (e.g., five or more) usage levels for finer-grained distinctions. For example, referring to FIGS. 1 and 4, the edge server may store a plurality of traffic-control configuration patterns in a traffic control patterns table 107 or 410, where the traffic control patterns table 107 or 410 may be stored in a memory of the edge server.

At 1330, the edge server may select, to execute an application associated with a set of desired network performance characteristics, a particular traffic-control configuration from a set of two or more traffic-control configurations in the plurality of traffic-control configurations. The set of two or more traffic-control configurations, in some aspects, include traffic-control configurations that meet the set of desired network performance characteristics for the application. In some aspects, the edge server may identify the set of two or more traffic-control configurations by comparing the set of desired network performance characteristics for the application with the estimated network performance characteristics associated with each of the plurality of traffic-control configurations. The particular traffic-control configuration selected, in some aspects, may be a traffic-control configuration of the set of two or more traffic-control configurations with a lowest associated estimated power usage or a lowest estimated power-usage level. For example, referring to FIGS. 1, 2, 4, and 5, edge server 110 (or orchestrator 116) may compare the set of desired network performance characteristics for the application associated with application ID #2 and the estimated network performance characteristics associated with different traffic control patterns in traffic control patterns table 107 or 410 to identify that traffic control patterns associated with traffic control pattern IDs #1 and #2 meet (or are expected to meet) the set of desired network performance characteristics and select the traffic control pattern associated with traffic control pattern ID #2 based on a lower expected power usage.

Finally, at 1340, the edge server may configure the communication node based on the particular traffic-control configuration. The edge server, based on the selected particular traffic-control configuration, may configure at least one of a physical interface, a network switch, or an application interface based on the particular traffic-control configuration. For example, referring to FIGS. 1 and 4, the edge server 110 (or the orchestrator 116) may identify one of a set of physical network interfaces 111, a network switching module 112, or one of a set of networking interfaces for applications 113 that is associated with the selected traffic control pattern based on one of fields 406-408 of table 410 and may configure the identified physical interface, network switch, or networking interface for application.

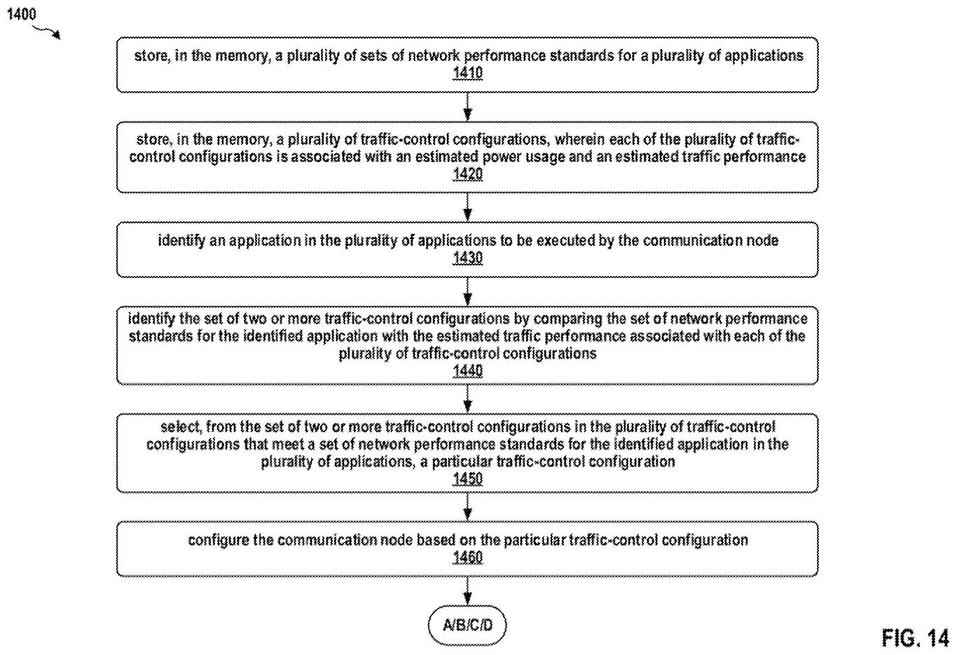

FIG. 14 is a flow diagram 1400 illustrating a method for providing traffic control for a set of applications. The method may be performed by a system, and more specifically an edge server (e.g., edge server 110) or an orchestrator of the edge server (e.g., orchestrator 116). At 1410, the edge server may store, in the memory, a plurality of sets of desired network performance characteristics for a plurality of applications. The set of desired network performance characteristics, in some aspects, may include one or more of a minimum throughput, a threshold jitter, or a threshold delay. For example, referring to FIGS. 1 and 2, the edge server 110 may store one or more sets of desired network performance characteristics in an application requirements table 105 or 210, where the application requirements table 105 or 210 may be stored in a memory of the edge server.

At 1420, the edge server may store, in the memory, a plurality of traffic-control configurations, wherein each of the plurality of traffic-control configurations is associated with an estimated power usage and a set of estimated network performance characteristics. In some aspects, the estimated network performance characteristics relate to one or more of a throughput, a jitter, or a delay. The estimated power usage, in some aspects, may include one or more of a numerical value (or range) associated with the estimated power usage or an estimated power-usage level. In some aspects, the estimated power-usage level includes one of a high power-usage level, a medium power-usage level, or a low power-usage level. In other aspects, the estimated power-usage level may include a more (e.g., five or mom) usage levels for finer-grained distinctions. For example, referring to FIGS. 1 and 4, the edge server may store a plurality of traffic-control configuration patterns in a traffic control patterns table 107 or 410, where the traffic control patterns table 107 or 410 may be stored in a memory of the edge server.

At 1430, the edge server may identify an application in the plurality of applications to be executed by the edge server (e.g., a communication node). For example, referring to FIGS. 1 and 2, the edge server 110r an orchestrator 116, may identify an application of the applications 115 to be executed. Based on the identified application, the edge server, at 1440, may identify a set of two or more traffic-control configurations that meet the set of desired network performance characteristics for the application identified at 1430. The edge server may identify the set of two or more traffic-control configurations by comparing the set of desired network performance characteristics for the application with the estimated network performance characteristics associated with each of the plurality of traffic-control configurations. For example, referring to FIGS. 1, 2, 4, and 5, edge server 130 (or orchestrator 116) may compare the set of desired network performance characteristics for the application associated with application ID #2 and the estimated network performance characteristics associated with different traffic control patterns in traffic control patterns table 107 or 410 to identify that traffic control patterns associated with traffic control pattern IDs #1 and #2 meet (or are expected to meet) the set of desired network performance characteristics.

At 1450, the edge server may select a particular traffic-control configuration from the set of two or more traffic-control configurations in the plurality of traffic-control configurations. The set of two or more traffic-control configurations, in some aspects, include traffic-control configurations that meet the set of desired network performance characteristics for the application and that may be associated with different estimated power usages (or power usage levels). The particular traffic-control configuration selected, in some aspects, may be a traffic-control configuration of the set of two or more traffic-control configurations with a lowest associated estimated power usage or a lowest estimated power-usage level. For example, referring to FIGS. 1 and 2 edge server 110 (or orchestrator 116) may select the traffic control pattern associated with traffic control pattern ID #2 based on a lower expected power usage.

Finally, at 1460, the edge server may configure the communication node based on the particular traffic-control configuration. The edge server, based on the selected particular traffic-control configuration, may configure at least one of a physical interface, a network switch, or an application interface based on the particular traffic-control configuration. For example, referring to FIGS. 1 and 4, the edge server 110 (or the orchestrator 116) may identify one of a set of physical network interfaces 111, a network switching module 112, or one of a set of networking interfaces for applications 113 that is associated with the selected traffic control pattern based on one of fields 406-408 of table 410 and may configure the identified physical interface, network switch, or networking interface for application.

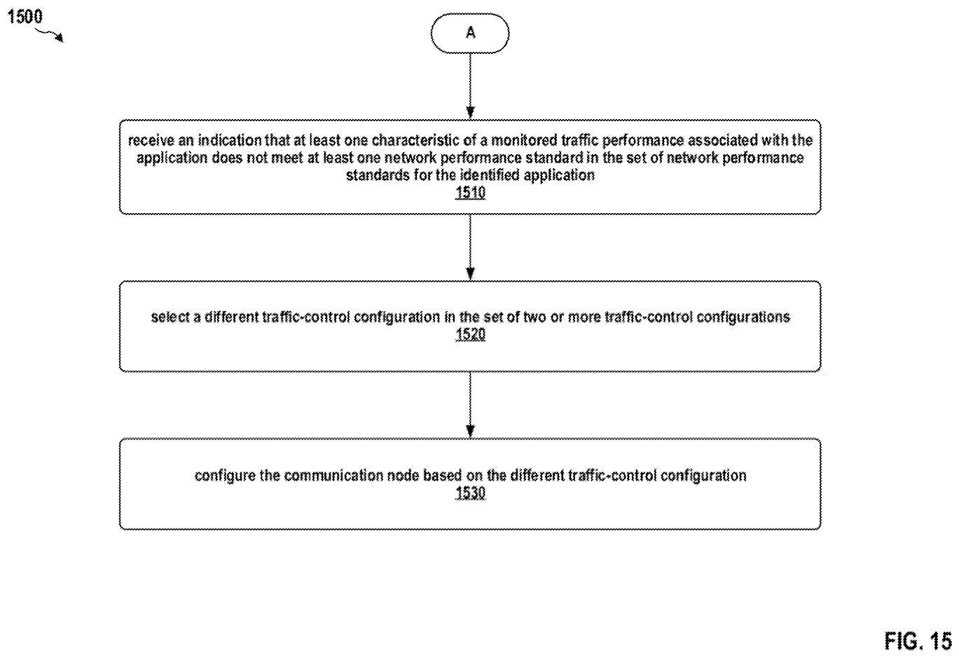

The methods illustrated in the flow diagrams 1300 and 1400 for providing traffic control for a set of applications may represent an initial configuration. Additional operations may be performed subsequent to the initial configuration as described in relation to FIGS. 15-18.

FIG. 15 is a flow diagram 1500 illustrating a method for updating a traffic control configuration based on monitoring network traffic performance associated with an application. The method may be performed by an edge server (e.g., edge server 110) or an orchestrator of an edge server (e.g., orchestrator 116). As indicated by the letter “A” at the beginning of the flow diagram 1500, the method may be performed after an initial configuration operation as described in FIGS. 13 and 14. At 1510, the edge server may receive an indication that at least one characteristic of a monitored traffic performance associated with the application does not meet at least one desired network performance characteristic in the set of desired network performance characteristics for the application. The at least one characteristic, in some aspects, may be one of a throughput, a jitter, and/or a delay. In some aspects, the at least one characteristic may have previously met the at least one desired network performance characteristic. For example, referring to FIGS. 1 and 7-11, an edge server 110, or an orchestrator 116, may receive an indication (e.g., from one of the set of field servers 103 or by examining a field status table 106) at time t_{d} that at least one network performance characteristic no longer meets, or is expected to no longer meet, the desired network performance characteristic as in FIGS. 8-11 based on a measurement of network performance. e.g., a measurement made at 710.

At 1520, the edge server may select a different traffic-control configuration in the set of two or more traffic-control configurations. The different traffic-control configuration may be a lower priority traffic control configuration pattern in the set of two or more traffic control configurations. For example, referring to FIGS. 1, 5, and 8-11, an edge server 110 may select, for an application identified by application ID #2, a different traffic control pattern from a set of two traffic control patters in a system status table 108 or 510 maintained by the edge server 110.

At 1530, the edge server may configure the communication node based on the different traffic-control configuration. The edge server, based on the different traffic-control configuration, may configure at least one of a physical interface, a network switch, or an application interface based on the particular traffic-control configuration. Configuring the at least one of the physical interface, the network switch, or the application interface may include configuring a different one of the physical interface, the network switch, or the application interface to provide switching functionality for the application than was initially configured (e.g., at 1340 or 1460). For example, referring to FIGS. 1 and 4, the edge server 110 (or the orchestrator 116) may identify one of a set of physical network interfaces 111, a network switching module 112, or one of a set of networking interfaces for applications 113 that is associated with the selected traffic control pattern based on one of fields 406-408 of table 410 and may configure the identified physical interface, network switch, or networking interface for application.

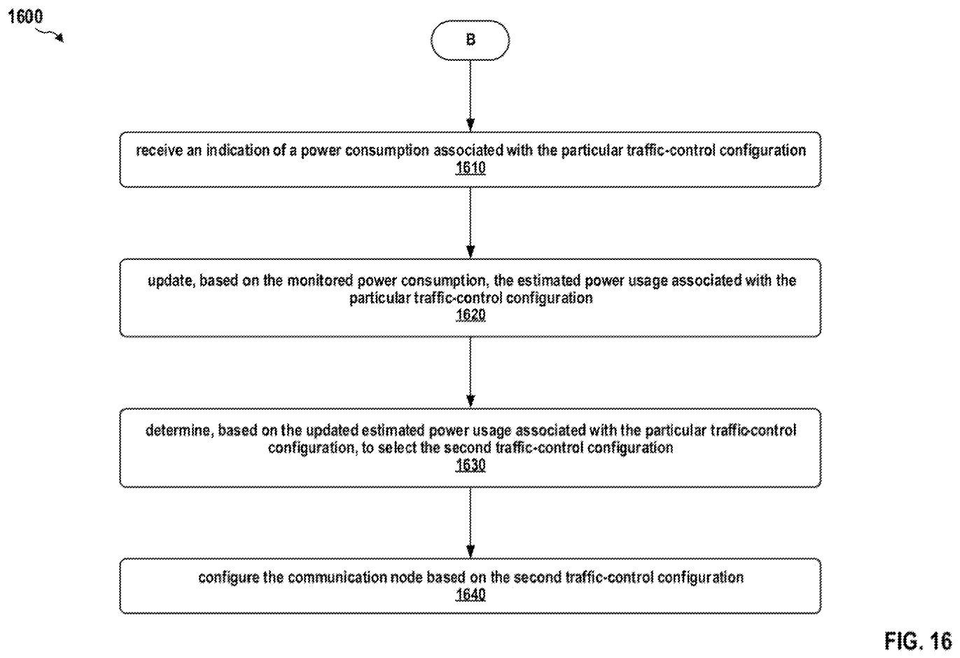

FIG. 16 is a flow diagram 1600 illustrating a method for updating a traffic control configuration based on monitoring power consumption associated with an application. The method may be performed by a system, and more specifically an edge server (e.g., edge server 110) or an orchestrator of the edge server (e.g., orchestrator 116). As indicated by the letter “B” at the beginning of the flow diagram 1600, the method may be performed after an initial configuration operation as described in FIGS. 13 and 14. At 1610, the edge server may receive an indication of a power consumption associated with the particular traffic-control configuration. The power consumption may be monitored by a power monitor of the edge server that may store the monitored power consumption in a field (e.g., a power field 507) of a system status table 108 or 510. For example, referring to FIGS. 1, 5, and 7, the edge server 110 may receive (via a power monitor 117, a system status table 108, and an orchestrator 116) an indication (via checking the field status 752) of a power consumed by the edge server in providing switching for an application.

At 1620, the edge server may update, based on the monitored power consumption, the estimated power usage associated with the particular traffic-control configuration. In some aspects, a relative priority of the particular traffic-control configuration compared to a second traffic-control configuration in the set of two or more traffic-control configurations may be affected by the updated estimated power usage associated with the particular traffic-control configuration. For example, if a monitored (or measured) power usage associated with a current traffic control pattern (the pattern identified by traffic control ID #2), exceeds an estimated power consumption of a second traffic control pattern in a set of two or more traffic control patterns that meet the set of desired network performance characteristics for the application, a relative priority of the current traffic control pattern and the second traffic control pattern may be adjusted. For example, referring to FIGS. 1 and 5, the edge server 110 may update an estimated power usage with a measured (actual) power usage in a power field 507 of system status table 510 or 108, such that a relative priority based on an ordered list of estimated power usage (e.g., with higher priority assigned to traffic control patterns associated with lower estimated power usages) may be updated based on the measured power consumption and/or usage.

At 1630, the edge server may determine, based on the updated estimated power usage associated with the particular traffic-control configuration, to select the second traffic-control configuration. As described in relation to updating the estimated power usage associated with the particular traffic-control configuration at 1620, the priority of the particular traffic-control configuration may, after the update, be lower than the priority of the second traffic-control configuration. Accordingly, the edge server may determine, based on the updated priority, to select the second traffic-control configuration to provide switching for the application instead of the particular traffic-control configuration previously selected.

Finally, at 1640, the edge server may configure the communication node based on the second traffic-control configuration. The edge server, based on the second traffic-control configuration, may configure at least one of a physical interface, a network switch, or an application interface based on the particular traffic-control configuration. Configuring the at least one of the physical interface, the network switch, or the application interface may include configuring a different one of the physical interface, the network switch, or the application interface to provide switching functionality for the application than was initially configured (e.g., at 1340 or 1460). For example, referring to FIGS. 1 and 4, the edge server 110 (or the orchestrator 116) may identify one of a set of physical network interfaces 111, a network switching module 112, or one of a set of networking interfaces for applications 113 that is associated with the selected traffic control pattern based on one of fields 406-408 of table 410 and may configure the identified physical interface, network switch, or networking interface for application.

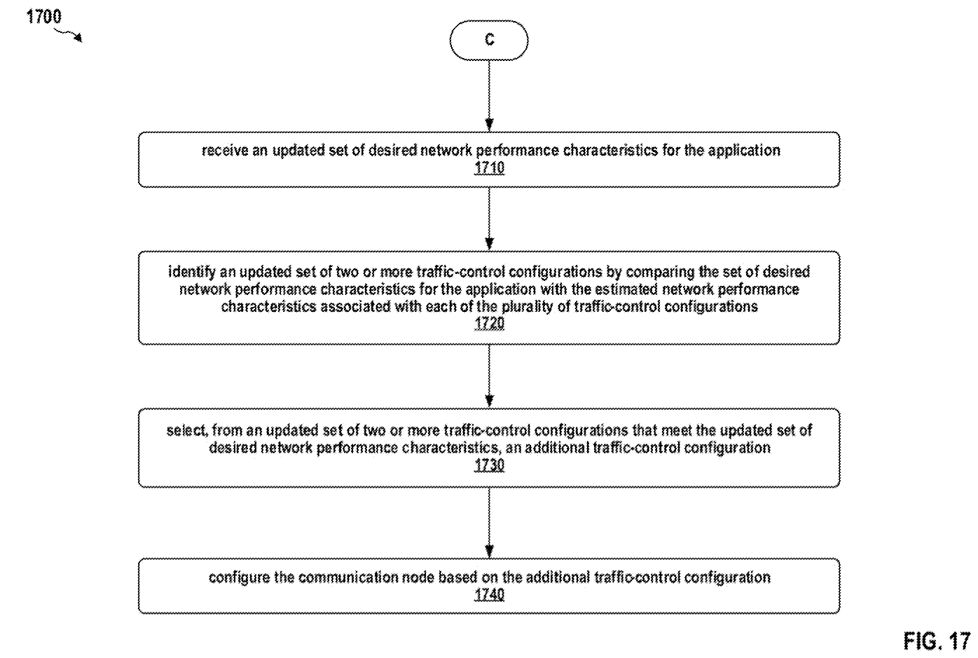

FIG. 17 is a flow diagram 1700 illustrating a method for updating a traffic control configuration based on an updated set of desired network performance characteristics associated with an application. The method may be performed by a system, and more specifically an edge server (e.g., edge server 110) or an orchestrator of the edge server (e.g., orchestrator 116). As indicated by the letter “C” at the beginning of the flow diagram 1700, the method may be performed after an initial configuration operation as described in FIGS. 13 and 14. At 1710, the edge server may receive an updated set of desired network performance characteristics for the application. The received update, in some aspects, may be an update to one of the plurality of sets of desired network performance characteristics for the plurality of applications stored in a application requirements table. The updated set of desired network performance characteristics, in some aspects, may include one or more of an updated minimum throughput, an updated threshold jitter, or an updated threshold delay. For example, referring to FIGS. 1 and 2, the edge server 110 may receive an updated set of desired network performance characteristics for an application in an application requirements table 105 or 210, where the application requirements table 105 or 210 may be stored in a memory of the edge server.

At 1720, the edge server may identify an updated set of two or more traffic-control configurations that meet the updated set of desired network performance characteristics for the application received at 1710. For example, referring to FIGS. 1 and 2, the edge server 110, or an orchestrator 116, may identify an updated set of two or more traffic-control configurations that meet the updated set of desired network performance characteristics for the application received at 1710. In some aspects, the edge server may identify the updated set of two or more traffic-control configurations by comparing the updated set of desired network performance characteristics for the application with the estimated network performance characteristics associated with each of the plurality of traffic-control configurations. For example, referring to FIGS. 1, 2, 4, and 5, edge server 110 (or orchestrator 116) may compare the updated set of desired network performance characteristics for the application associated with application ID #2 and the estimated network performance characteristics associated with different traffic control patterns in traffic control patterns table 107 or 410 to identify that traffic control patterns associated with traffic control pattern IDs #1 and #2 meet (or are expected to meet) the set of desired network performance characteristics.

At 1730, the edge server may select, from the updated set of two or more traffic-control configurations that meet the updated set of desired network performance characteristics, an additional traffic-control configuration. The updated set of two or more traffic-control configurations, in some aspects, include traffic-control configurations that meet the updated set of desired network performance characteristics for the application and that may be associated with different estimated power usages (or power usage levels). The particular traffic-control configuration selected, in some aspects, may be a traffic-control configuration of the set of two or more traffic-control configurations with a lowest associated estimated power usage or a lowest estimated power-usage level. For example, referring to FIGS. 1 and 2 edge server 110 (or orchestrator 116) may select the traffic control pattern associated with traffic control pattern ID #2 based on a lower expected power usage.

Finally, at 1740, the edge server may configure the communication node based on the particular traffic-control configuration. The edge server, based on the selected particular traffic-control configuration, may configure at least one of a physical interface, a network switch, or an application interface based on the particular traffic-control configuration. For example, referring to FIGS. 1 and 4, the edge server 110 (or the orchestrator 116) may identify one of a set of physical network interfaces 111, a network switching module 112, or one of a set of networking interfaces for applications 113 that is associated with the selected traffic control pattern based on one of fields 406-408 of table 410 and may configure the identified physical interface, network switch, or networking interface for application.

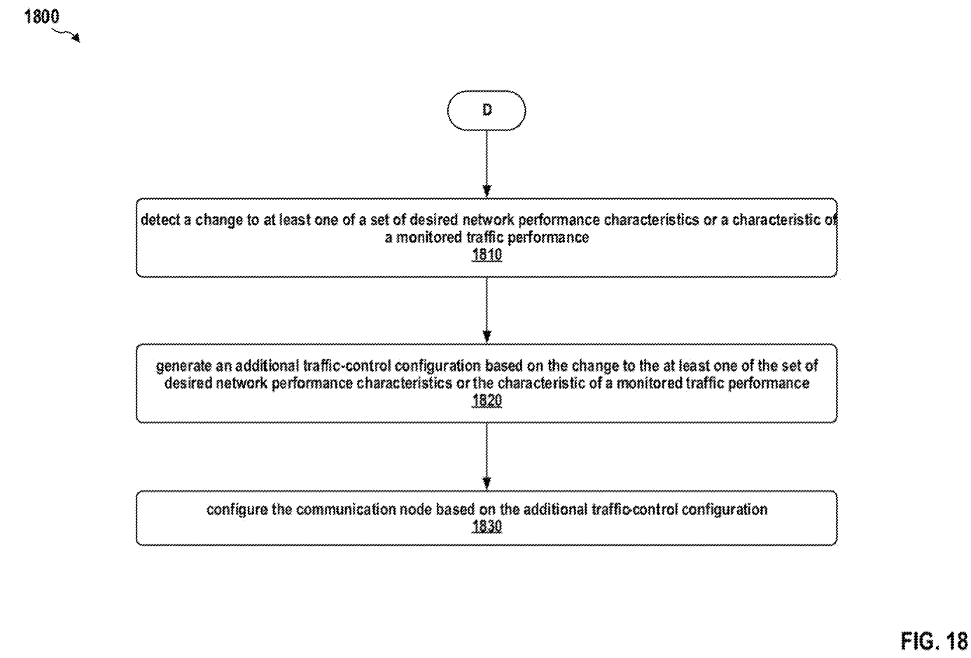

FIG. 18 is a flow diagram 1800 illustrating a method for updating a set of traffic control configurations based on an updated set of desired network performance characteristics associated with an application. The method may be performed by a system, and more specifically an edge server (e.g., edge server 110) or an orchestrator of the edge server (e.g., orchestrator 116). As indicated by the letter “D” at the beginning of the flow diagram 1800, the method may be performed after an initial configuration operation as described in FIGS. 13 and 14. At 1810, the edge server may detect a change to at least one of a set of desired network performance characteristics or a characteristic of a monitored traffic performance. The edge server may detect the change based on a change to an application requirements table or a system status table. For example, referring to FIGS. 1, 5, and 7, the edge server 110 may detect (e.g., via checking the field status 752 an update received via a field server 103, a power monitor 117, a system status table 108, and an orchestrator 116) of a change to at least one of a set of desired network performance characteristics or may detect a change to an application requirements table 105.

At 1820, the edge server may generate an additional traffic-control configuration based on the change to the at least one of the set of desired network performance characteristics or the characteristic of a monitored traffic performance. Based on the detected change, no traffic control pattern may meet at least one set of desired network performance characteristics and the edge server may generate a traffic control patter (configuration) to meet the at least one set of desired network performance characteristic. For example, referring to FIGS. 1-5, the edge server 110 may determine that a desired set of network performance characteristics in an application requirements table 105 or 210 is not met by any traffic control pattern in a traffic control patterns table 107 or 410 based on a measured performance characteristic in a field status table 106 or 310 or a measured power usage in system status table 108 or 510 and generate an additional traffic control pattern to meet the desired set of network performance characteristics.

Finally, at 1830, the edge server may configure the communication node based on the additional traffic-control configuration. The edge server, based on the additional traffic-control configuration, may configure at least one of a physical interface, a network switch, or an application interface based on the additional traffic-control configuration. For example, referring to FIGS. 1 and 4, the edge server 110 (or the orchestrator 116) may identify one of a set of physical network interfaces 111, a network switching module 112, or one of a set of networking interfaces for applications 113 that is associated with the additional traffic control pattern based on one of fields 406-408 of table 410 and may configure the identified physical interface, network switch, or networking interface for application.

According to the examples described above, it is possible for an edge server to utilize resources based on the power consumption by selecting an optimal interface from several interfaces. Additionally, the edge server may be capable of changing the method of traffic control to optimize power consumption while maintaining the network performance required for the applications.

According to the present disclosure, the edge server may flexibly provide traffic control while meeting network performance requirements (e.g., desired network performance characteristics) of applications. Each of the aspects and examples described above may be combined with each other. While examples of an apparatus and methods are described above they do not limit the subject matter of this disclosure. Other modes considered to fail within the technical scope of the novel apparatus and methods are also covered by the present disclosure. Moreover, the novel apparatus and methods may not include all of the details explained in relation to the examples above. Furthermore, control lines and information lines are illustrated to the extent required for explaining the novel apparatus and methods, and not all control lines and information lines required for the product may necessarily be indicated. In effect, it may be understood that nearly all of the configurations are mutually connected.

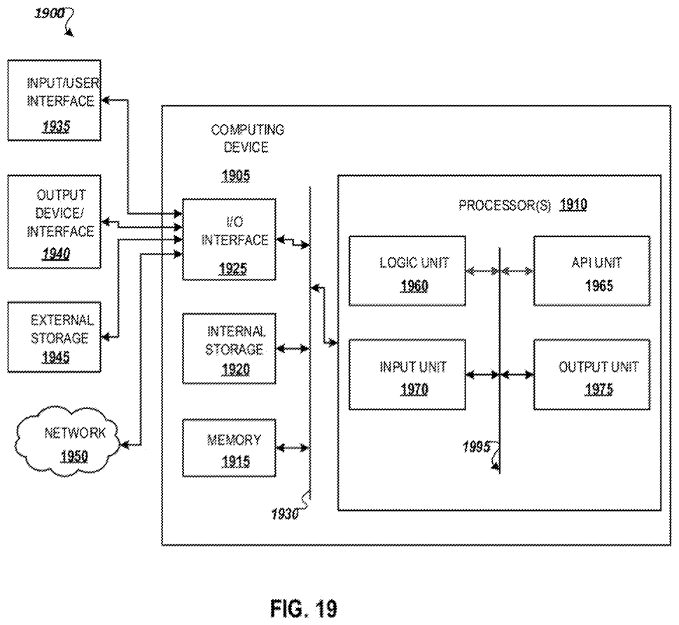

FIG. 19 illustrates an example computing environment with an example computer device suitable for use in some example implementations. Computer device 1905 in computing environment 1900 can include one or more processing units, cores, or processors 1910, memory 1915 (e.g., RAM, ROM, and/or the like), internal storage 1920 (e.g., magnetic, optical, solid-state storage, and/or organic), and/or 10 interface 1925, any of which can be coupled on a communication mechanism or bus 1930 for communicating information or embedded in the computer device 1905. IO interface 1925 is also configured to receive images from cameras or provide images to projectors or displays, depending on the desired implementation.

Computer device 1905 can be communicatively coupled to input/user interface 1935 and output device/interface 1940. Either one or both of the input/user interface 1935 and output device/interface 1940 can be a wired or wireless interface and can be detachable. Input/user interface 1935 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 1940 may include a display, television, monitor, printer, speaker, braille, or the like. In some example implementations, input/user interface 1935 and output device/interface 1940 can be embedded with or physically coupled to the computer device 1905. In other example implementations, other computer devices may function as or provide the functions of input/user interface 1935 and output device/interface 1940 for a computer device 1905.

Examples of computer device 1905 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1905 can be communicatively coupled (e.g., via 10 interface 1925) to external storage 1945 and network 1950 for communicating with any number of networked components, devices, and systems, including one or more computer devices of the same or different configuration. Computer device 1905 or any connected computer device can be functioning as, providing services of, or referred to as a server, client, thin server, general machine, special-purpose machine, or another label.

IO interface 1925 can include but is not limited to, wired and/or wireless interfaces using any communication or IO protocols or standards (e.g., Ethernet, 1902.11x. Universal System Bus, WiMax, modem, a cellular network protocol, and the like) for communicating information to and/or from at least al the connected components, devices, and network in computing environment 1900. Network 1950 can be any network or combination of networks (e.g., the Internet, local area network, wide area network, a telephonic network, a cellular network, satellite network, and the like).

Computer device 1905 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 1905 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1910 can execute under any operating system (OS) (not shown), in a native or virtual environment. One or more applications can be deployed that include logic unit 1960, application programming interface (API) unit 1965, input unit 1970, output unit 1975, and inter-unit communication mechanism 1995 for the different units to communicate with each other, with the OS, and with other applications (not shown). The described units and elements can be varied in design, function, configuration, or implementation and are not limited to the descriptions provided. Processor(s) 1910 can be in the form of hardware processors such as central processing units (CPUs) or in a combination of hardware and software units.

In some example implementations, when information or an execution instruction is received by API unit 1965, it may be communicated to one or more other units (e.g., logic unit 1960, input unit 1970, output unit 1975). In some instances, logic unit 1960 may be configured to control the information flow among the units and direct the services provided by API unit 1965, the input unit 1970, the output unit 1975, in some example implementations described above. For example, the flow of one or more processes or implementations may be controlled by logic unit 1960 alone or in conjunction with API unit 1965. The input unit 1970 may be configured to obtain input for the calculations described in the example implementations, and the output unit 1975 may be configured to provide an output based on the calculations described in example implementations.

Processor(s) 1910 can be configured to store, in the memory, a set of desired network performance characteristics for an application. The processor(s) 1910 may also be configured to store, in the memory, a plurality of traffic-control configurations, wherein each of the plurality of traffic-control configurations is associated with an estimated power usage and a set of estimated network performance characteristics. The processor(s) 1910 may further be configured to select, to execute the application, a particular traffic-control configuration from a set of two or more traffic-control configurations in the plurality of traffic-control configurations, wherein the set of two or more traffic-control configurations meet the set of desired network performance characteristics for the application. The processor(s) 1910 may further be configured to configure the communication node based on the particular traffic-control configuration. The processor(s) 1910 may also be configured to identify the set of two or more traffic-control configurations by comparing the set of desired network performance characteristics for the application with the estimated network performance characteristics associated with each of the plurality of traffic-control configurations. The processor(s) 1910 may also be configured to configure at least one of a physical interface, a network switch, or an application interface based on the particular traffic-control configuration. The processor(s) 1910 may also be configured to receive an indication that at least one characteristic of a monitored traffic performance associated with the application does not meet at least one desired network performance characteristic in the set of desired network performance characteristics for the application. The processor(s) 1910 may further be configured to select a different traffic-control configuration in the set of two or more traffic-control configurations. The processor(s) 1910 may further be configured to configure the communication node based on the different traffic-control configuration. The processor(s) 1910 may also be configured to receive an indication of a power consumption associated with the particular traffic-control configuration. The processor(s) 1910 may further be configured to update, based on the monitored power consumption, the estimated power usage associated with the particular traffic-control configuration. The processor(s) 1910 may further be configured to determine, based on the updated estimated power usage associated with the particular traffic-control configuration, to select the second traffic-control configuration. The processor(s) 1910 may further be configured to configure the communication node based on the second traffic-control configuration. The processor(s) 1910 may further be configured to receive an updated set of desired network performance characteristics for the application. The processor(s) 1910 may further be configured to identify an updated set of two or more traffic-control configurations by comparing the set of desired network performance characteristics for the application with the estimated network performance characteristics associated with each of the plurality of traffic-control configurations. The processor(s) 1910 may further be configured to select, from the updated set of two or more traffic-control configurations that meet the updated set of desired network performance characteristics, an additional traffic-control configuration. The processor(s) 1910 may further be configured to configure the communication node based on the additional traffic-control configuration. The processor(s) 1910 may further be configured to detect change to at least one of a set of desired network performance characteristics or a characteristic of a monitored traffic performance. The processor(s) 1910 may further be configured to generate an additional traffic-control configuration based on the change to the at least one of the set of desired network performance characteristics or the characteristic of a monitored traffic performance. The processor(s) 1910 may further be configured to configure the communication node based on the additional traffic-control configuration.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specially stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present applicate may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed:

1. An apparatus at a communication node, the apparatus comprising:
a memory; and
at least one processor coupled to the memory and configured to:
store, in the memory, a set of desired network performance characteristics for an application;
store, in the memory, a plurality of traffic-control configurations, wherein each of the plurality of traffic-control configurations is associated with an estimated power usage and a set of estimated network performance characteristics;
select, to execute the application, a particular traffic-control configuration from a set of two or more traffic-control configurations in the plurality of traffic-control configurations, wherein the set of two or more traffic-control configurations meet the set of desired network performance characteristics for the application; and
configure the communication node based on the particular traffic-control configuration.

2. The apparatus of claim 1, wherein the set of desired network performance characteristics comprises one or more of a minimum throughput, a threshold jitter, or a threshold delay.

3. The apparatus of claim 1, wherein the set of estimated network performance characteristics relate to one or more of a throughput, a jitter, or a delay.

4. The apparatus of claim 1, wherein the estimated power usage comprises one or more of a numerical value associated with the estimated power usage or an estimated power-usage level, wherein the estimated power-usage level comprises one of a high power-usage level, a medium power-usage level, or a low power-usage level.

5. The apparatus of claim 4, wherein the particular traffic-control configuration is a traffic-control configuration of the set of two or more traffic-control configurations with a lowest associated estimated power usage or a lowest estimated power-usage level.

6. The apparatus of claim 1, wherein the at least one processor is further configured to:
identify the set of two or more traffic c-control configurations by comparing the set of desired network performance characteristics for the application with the set of estimated network performance characteristics associated with each of the plurality of traffic-control configurations.

7. The apparatus of claim 1, wherein, to configure the communication node based on the particular traffic-control configuration, the at least one processor is configured to:
configure at least one of a physical interface, a network switch, or an application interface based on the particular traffic-control configuration.

8. The apparatus of claim 1, wherein the at least one processor is further configured to:
receive an indication that at least one characteristic of a monitored traffic performance associated with the application does not meet at least one desired network performance characteristic in the set of desired network performance characteristics for the application; select a different traffic-control configuration in the set of two or more traffic-control configurations; and
configure the communication node based on the different traffic-control configuration.

9. The apparatus of claim 8, wherein the at least one characteristic is one of a throughput, a jitter, and a delay and the at least one characteristic previously met the at least one desired network performance characteristic.

10. The apparatus of claim 1, wherein the at least one processor is further configured to:
receive an indication of a power consumption associated with the particular traffic-control configuration.

11. The apparatus of claim 10, wherein the at least one processor is further configured to:
update, based on the indication of the power consumption, the estimated power usage associated with the particular traffic-control configuration, wherein a relative priority of the particular traffic-control configuration compared to a second traffic-control configuration in the set of two or more traffic-control configurations is affected by the updated estimated power usage associated with the particular traffic-control configuration.

12. The apparatus of claim 11, wherein the at least one processor is further configured to:
determine, based on the updated estimated power usage associated with the particular traffic-control configuration, to select the second traffic-control configuration; and
configure the communication node based on the second traffic-control configuration.

13. The apparatus of claim 1, wherein the at least one processor is further configured to:
receive an updated set of desired network performance characteristics for the application;
identify an updated set of two or more traffic-control configurations by comparing the set of desired network performance characteristics for the application with the estimated network performance characteristics associated with each of the plurality of traffic-control configurations;
select, from the updated set of two or more traffic-control configurations that meet the updated set of desired network performance characteristics, an additional traffic-control configuration; and
configure the communication node based on the additional traffic-control configuration.

14. The apparatus of claim 1, wherein the at least one processor is further configured to:
detect a change to at least one of the set of desired network performance characteristics or a characteristic of a monitored traffic performance;
generate an additional traffic-control configuration based on the change to the set of desired network performance characteristics or the characteristic of the monitored traffic performance; and
configure the communication node based on the additional traffic-control configuration.

15. A method for a communication node comprising:
storing, in a memory of the communication node, a set of desired network performance characteristics for an application;
storing, in the memory of the communication node, a plurality of traffic-control configurations, wherein each of the plurality of traffic-control configurations is associated with an estimated power usage and a set of estimated network performance characteristics; selecting, to execute the application, a particular traffic-control configuration from a set of two or more traffic-control configurations in the plurality of traffic-control configurations, wherein the set of two or more traffic-control configurations meet the set of desired network performance characteristics for the application; and
configuring the communication node based on the particular traffic-control configuration.

16. The method of claim 15,
wherein the set of desired network performance characteristics comprises one or more of a minimum throughput, a threshold jitter, or a threshold delay,
wherein the set of estimated network performance characteristics relate to one or more of a throughput, a jitter, or a delay, and
wherein the estimated power usage comprises one or more of a numerical value associated with the estimated power usage or an estimated power-usage level, wherein the estimated power-usage level comprises one of a high power-usage level, a medium power-usage level, or a low power-usage level.

17. The method of claim 16, wherein the particular traffic-control configuration is a traffic-control configuration of the set of two or more traffic-control configurations with a lowest associated estimated power usage or a lowest estimated power-usage level.

18. The method of claim 17, further comprising:
identifying the set of two or more traffic-control configurations by comparing the set of desired network performance characteristics for the application with the set of estimated network performance characteristics associated with each of the plurality of traffic-control configurations; and
configuring the communication node based on the particular traffic-control configuration by configuring at least one of a physical interface, a network switch, or an application interface based on the particular traffic-control configuration.

19. The method of claim 15, further comprising:
receiving an indication that at least one characteristic of a monitored traffic performance associated with the application does not meet at least one desired network performance characteristic in the set of desired network performance characteristics for the application; selecting a different traffic-control configuration in the set of two or more traffic-control configurations; and
configuring the communication node based on the different traffic-control configuration.

20. A system comprising:
a first apparatus at a communication node, the first apparatus comprising:
a memory; and
at least one processor coupled to the memory and configured to:
store, in the memory, a set of desired network performance characteristics for an application;
store, in the memory, a plurality of traffic-control configurations, wherein each of the plurality of traffic-control configurations is associated with an estimated power usage and a set of estimated network performance characteristics;
select, to execute the application, a particular traffic-control configuration from a set of two or more traffic-control configurations in the plurality of traffic-control configurations,
wherein the set of two or more traffic-control configurations meet the set of desired network performance characteristics for the application; and
configure the communication node based on the particular traffic-control configuration; and
a second apparatus comprising:
a memory; and
at least one processor coupled to the memory and configured to:
to monitor at least one characteristic of a traffic performance associated with the application; and
transmit an indication of a value associated with the at least one characteristic of the traffic performance to the first apparatus.
